(19) United States
(12) Patent Application Publication
(10) Pub. No.: US 2008/0297342 A1
(43) Pub. Date: Dec. 4, 2008

(54) PATROLLING METHOD AND SYSTEM

(76) Inventor: Tung-Ming WU, Tainan City (TW)

Correspondence Address: OSTROLENK FABER GERB & SOFFEN, 1180 AVENUE OF THE AMERICAS, NEW YORK, NY, 100368403, US

(21) Appl. No.: 11/756,006

(22) Filed: May 31, 2007

(51) Int. Cl. G08B 1/08

(52) U.S. Cl. 340/539.13

(57) ABSTRACT

A patrolling method includes the steps of: installing transponders at sites to be monitored, respectively; providing a patrol guard with a transceiver unit such that the patrol guard is able to use the transceiver unit to detect the transponders; enabling operation of the transceiver unit to forward patrol information retrieved from the transponders to a monitoring station; and enabling operation of the transceiver unit to forward a current geographic location thereof to the monitoring station. A patrolling system, which includes the transponders, the transceiver unit and the monitoring station, is also disclosed.

### BACKGROUND OF THE INVENTION

1. Field of the Invention

The invention relates to a patrolling method and system, more particularly to a tamper-free patrolling method and system.

2. Description of the Related Art

In a conventional patrolling method, patrol boxes are installed at sites to be monitored, a patrol guard visits one of the sites to be monitored, and writes down patrol information on a notebook placed in the patrol box installed at the visited site.

The aforementioned patrolling method is disadvantageous in that, since the patrol guard follows a fixed route and the patrol boxes are not locked, lawbreakers have easy access to the notebooks, and the patrol information in the notebooks are therefore prone to tampering and may be maliciously used by the lawbreakers.

To solve this problem, it has been proposed to use a radio frequency identification (RFID) tag, in place of the notebook, and equip the patrol guard with an RFID writer for writing the patrol information into the RFID tag.

It is further desirable to determine a current geographical location of the patrol guard who is visiting different sites to be monitored.

### SUMMARY OF THE INVENTION

According to an aspect of the present invention, a patrolling method is to be implemented using a monitoring station, a plurality of transponders that have corresponding patrol information stored therein, and a transceiver unit that includes a sensor module capable of retrieving the patrol information from the transponders, a first transceiver module capable of forwarding retrieved patrol information to the monitoring station, and a second transceiver module capable of determining a current geographic location of the transceiver unit and forwarding the current geographic location to the monitoring station. The patrolling method comprises the steps of:

a) installing the transponders at a plurality of sites to be monitored, respectively;

b) providing a patrol guard with the transceiver unit such that the patrol guard is able to use the transceiver unit to detect the transponder installed at one of the sites to be monitored so as to retrieve the patrol information thereof;

c) enabling operation of the transceiver unit to forward the retrieved patrol information to the monitoring station via the first transceiver module; and

d) enabling operation of the transceiver unit to forward the current geographic location thereof to the monitoring station via the second transceiver module.

According to another aspect of the present invention, a patrolling system comprises a monitoring station, a plurality of transponders, and a transceiver unit. The transponders have corresponding patrol information stored therein, and are adapted to be installed at a plurality of sites to be monitored, respectively. The transceiver unit includes a sensor module, and first and second transceiver modules. The sensor module is capable of detecting the transponders so as to retrieve the patrol information therefrom. The first transceiver module is capable of forwarding retrieved patrol information to the monitoring station. The second transceiver module is capable of determining a current geographic location of the transceiver unit and forwarding the current geographic location to the monitoring station.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the preferred embodiment of a patrolling system according to the present invention;

FIG. 2 is a block diagram of the preferred embodiment;

FIG. 3 is a flowchart to illustrate the first preferred embodiment of a patrolling method according to the present invention;

FIG. 4 is a flowchart to illustrate the second preferred embodiment of a patrolling method according to the present invention; and

FIG. 5 is a flowchart to illustrate the third preferred embodiment of a patrolling method according to the present invention.

### DETAILED DESCRIPTION OF THE PREFERRED EMBODIMENTS

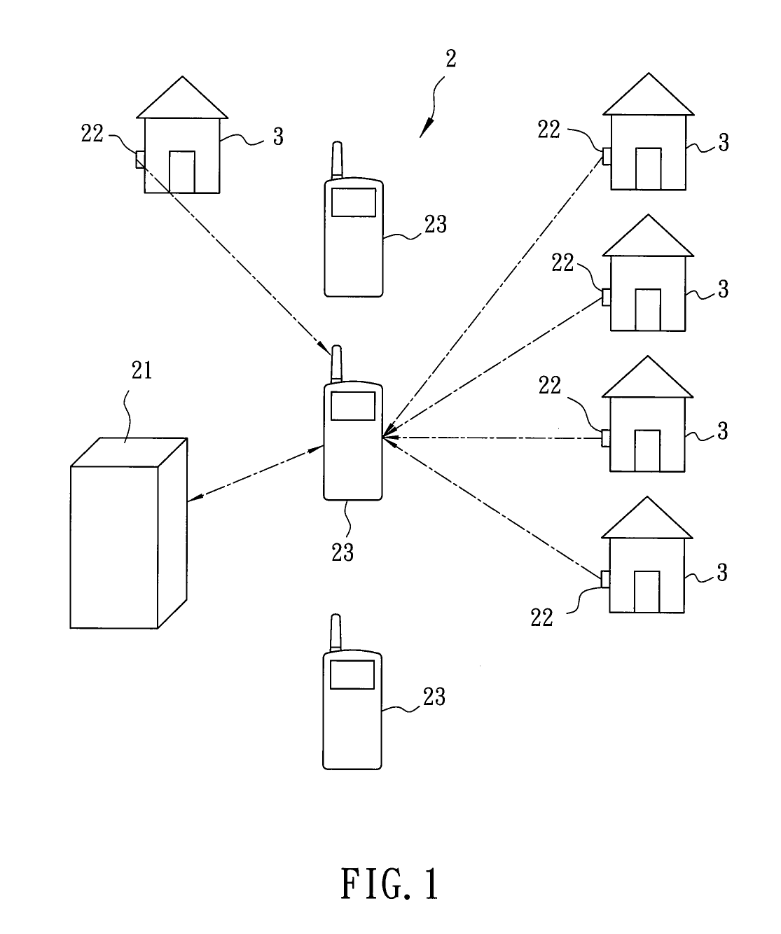

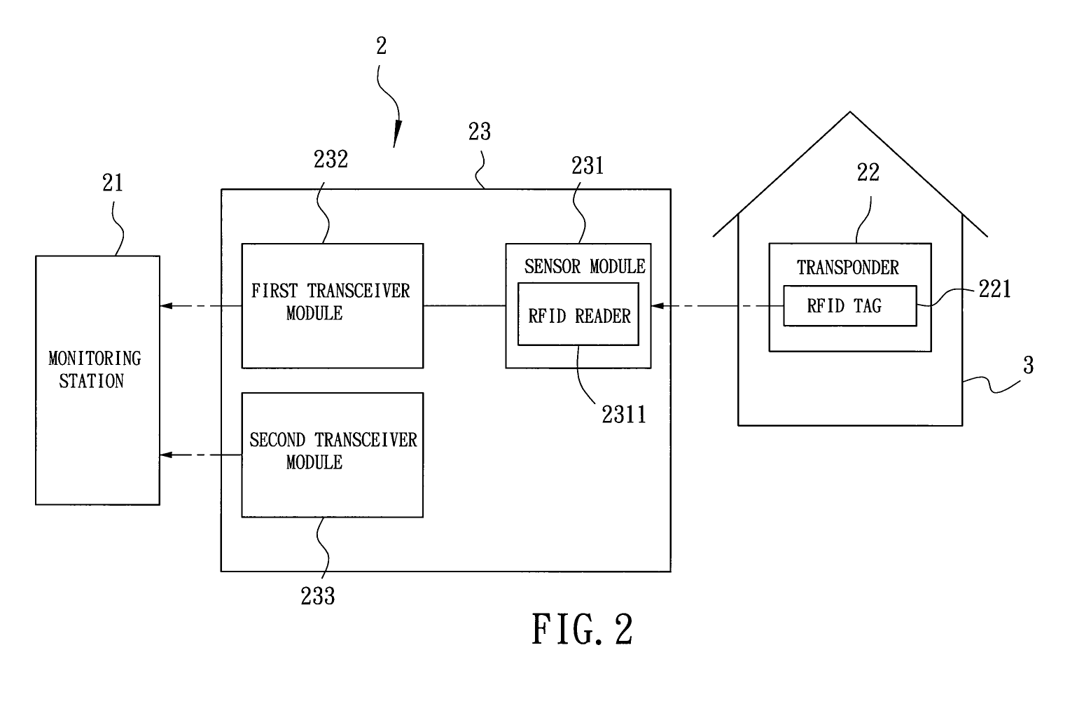

Referring to FIGS. 1 and 2, the preferred embodiment of a patrolling system 2 according to this invention is shown to include a monitoring station 21, a plurality of transponders 22, and a plurality of transceiver units 23.

The patrolling system 2 of this embodiment is employed to facilitate monitoring of a plurality of sites 3 for security purposes, in a manner that will be described hereinafter.

The transponders 22 are installed at the sites 3 to be monitored, respectively. In this embodiment, each of the transponders 22 includes a radio frequency identification (RFID) tag 221 that stores corresponding patrol information therein.

It is noted that since the RFID tag 221 of the transponder 22 is relatively inexpensive, the number of transponders 22 may be increased without a considerable affect on installation costs.

Since the transceiver units 23 are identical in structure and operation, only one of the transceiver units 23 will be described herein.

The transceiver unit 23 is assigned to a patrol guard (not shown), and includes a sensor module 231, and first and second transceiver modules 232, 233.

The sensor module 231 of the transceiver unit 23 includes a RFID reader 2311 that is capable of detecting the RFID tags 221 of the transponders 22 so as to retrieve, i.e., read, the patrol information stored from the RFID tags 221 of the transponders 22, in a conventional manner.

The first transceiver module 232 of the transceiver unit 23 is coupled to the sensor module 231, and is capable of forwarding retrieved patrol information to the monitoring station 21.

In this embodiment, the first transceiver module 232 is configured to forward the retrieved patrol information to the monitoring station 21 immediately upon detection by the RFID reader 2311 of the sensor module 231 of the RFID tag 221 of the transponder 22 at one of the sites 3 to be monitored.

In an alternative embodiment, the first transceiver module 232 is configured to forward the retrieved patrol information to the monitoring station 21 after detection by the RFID reader 2311 of the sensor module 231 of the RFID tags 221 of the transponders 22 at a predetermined set of the sites 3. The predetermined set of the sites 3 may include one or more of the sites 3 to be monitored.

It is noted that the first transceiver module 232 accesses a service, such as a General Packet Radio Service (GPRS) or a Short Message Service (SMS), provided by a mobile communications service provider (not shown), such as a Global System for Mobile Communications (GSM) provider (not shown), in forwarding the patrol information to the monitoring station 21.

The second transceiver module 233 of the transceiver unit 23 is capable of determining a current geographic location of the transceiver unit 23 and forwarding the current geographic location of the transceiver unit 23 to the monitoring station 21.

In this embodiment, the second transceiver module 233 is configured to forward the current geographic location of the transceiver unit 23 to the monitoring station 21 upon detection of a change in the current geographic location. This keeps the patrol guard under surveillance by the monitoring station 21, thus safeguarding the patrol guard.

In an alternative embodiment, the second transceiver module 233 is configured to forward the current geographic location of the transceiver unit 23 to the monitoring station 21 upon detection by the RFID reader 2311 of the sensor module 231 of the RFID tag 221 of the transponder 22 at one of the sites 3 to be monitored. This reduces battery power consumption of the transceiver unit 23, and thus optimizes operating time of the transceiver unit 23.

It is noted that the second transceiver module 233 accesses a service provided by a global positioning system (GPS) service provider (not shown) in determining the current geographic location of the transceiver unit 23.

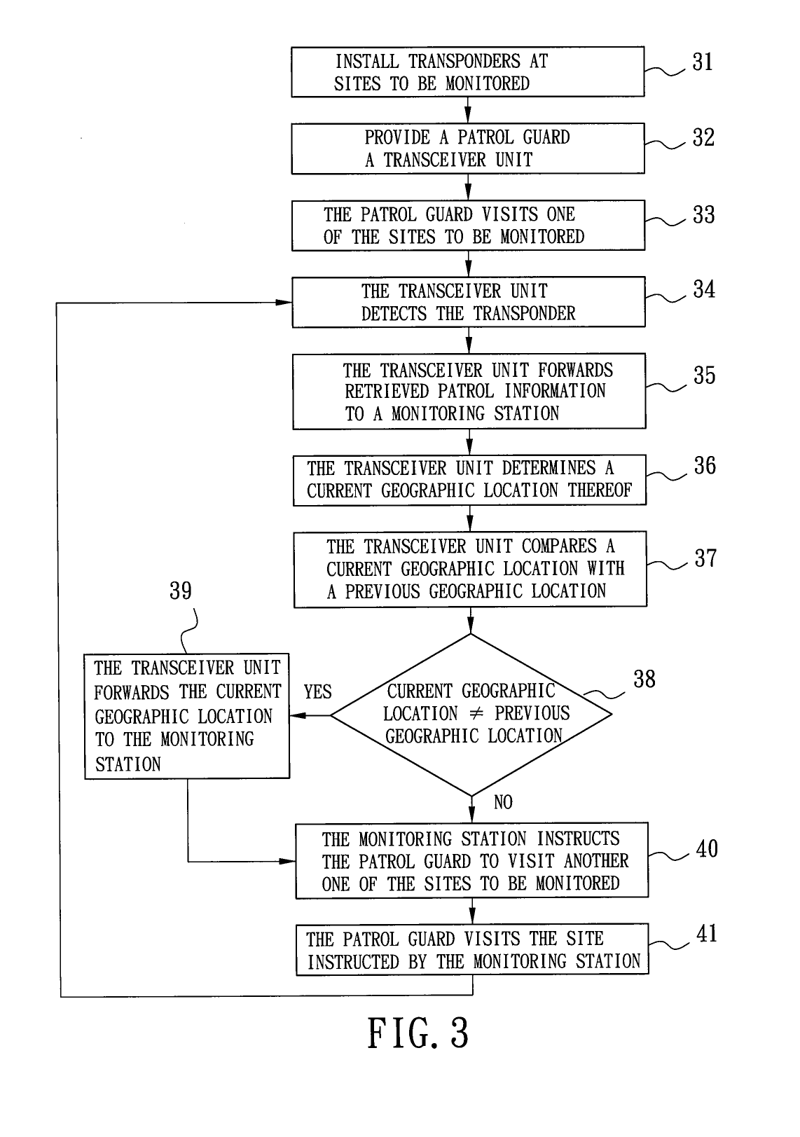

The first preferred embodiment of a patrolling method to be implemented using the aforementioned patrolling system 2 according to this invention includes the steps shown in FIG. 3.

In step 31, the transponders 22 are installed at the sites 3 to be monitored, respectively.

In step 32, the patrol guard is provided with the transceiver unit 23.

In step 33, the patrol guard visits one of the sites 3 to be monitored.

In step 34, the patrol guard uses the RFID reader 2311 of the sensor module 231 of the transceiver unit 23 to detect the RFID tag 221 of the transponder 22 installed at the visited site 3 so as to retrieve the patrol information thereof.

In step 35, the first transceiver module 232 of the transceiver unit 23 forwards the retrieved patrol information to the monitoring station 21.

In step 36, the second transceiver module 233 of the transceiver unit 23 determines a current geographic location of the transceiver unit 23.

In step 37, the second transceiver module 233 of the transceiver unit 23 compares the current geographic location determined thereby in step 36 with a previous geographic location determined thereby prior to step 36.

In step 38, if the second transceiver module 233 of the transceiver unit 23 determines in step 37 that the current geographic location is different from the previous geographic location, the flow proceeds to step 39. Otherwise, the flow proceeds to step 40.

In step 39, the second transceiver module 233 of the transceiver unit 23 forwards the current geographic location to the monitoring station 21.

In step 40, the monitoring station 21 instructs the patrol guard to visit another one of the sites 3 to be monitored.

In this embodiment, the monitoring station 21 randomly selects said another one of the sites 3 to be monitored. This offers better security against crime.

In one embodiment, the monitoring station 21 selects said another one of the sites 3 to be monitored in order of distance from the visited site 3.

In another embodiment, the monitoring station 21 selects said another one of the sites 3 to be monitored in order of time since a site 3 was last visited.

In yet another embodiment, the monitoring station 21 selects said another one of the sites 3 to be monitored in order of importance.

In step 41, the patrol guard visits said another one of the sites 3 to be monitored. Thereafter, the flow goes back to step 34.

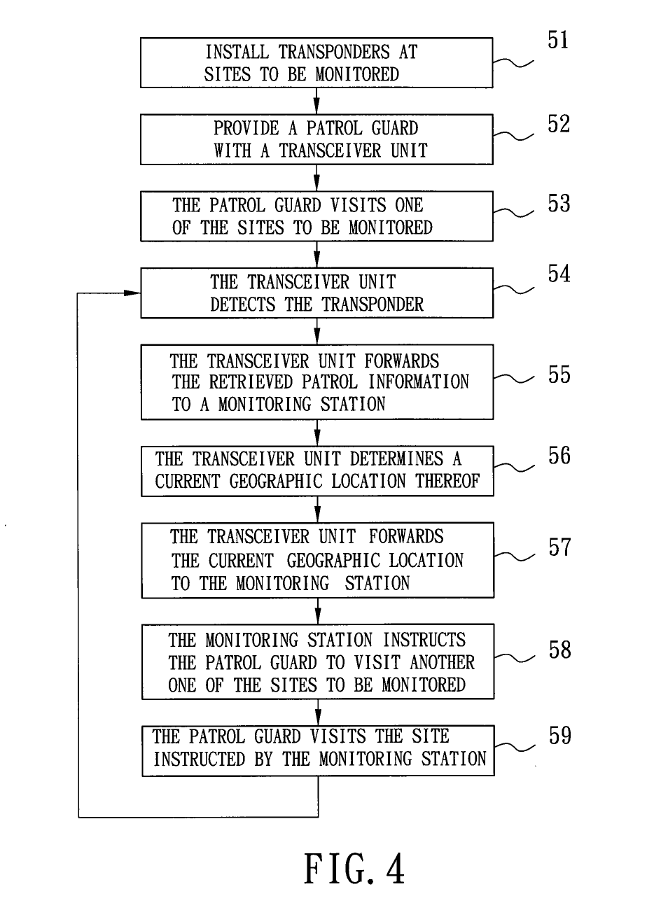

The second preferred embodiment of a patrolling method to be implemented using the aforementioned patrolling system 2 according to this invention includes the steps shown in FIG. 4.

In step 51, the transponders 22 are installed at the sites 3 to be monitored, respectively.

In step 52, the patrol guard is provided with the transceiver unit 23.

In step 53, the patrol guard visits one of the sites 3 to be monitored.

In step 54, the patrol guard uses the RFID reader 2311 of the sensor module 231 of the transceiver unit 23 to detect the RFID tag 221 of the transponder 22 installed at the visited site 3 so as to retrieve the patrol information thereof.

In step 55, the first transceiver module 232 of the transceiver unit 23 forwards the retrieved patrol information to the monitoring station 21.

In step 56, the second transceiver module 233 of the transceiver unit 23 determines a current geographic location of the transceiver unit 23.

In step 57, the second transceiver module 233 of the transceiver unit 23 forwards the current geographic location to the monitoring station 21.

In step 58, the monitoring station 21 instructs the patrol guard to visit another one of the sites 3 to be monitored.

In step 59, the patrol guard visits said another one of the sites 3 to be monitored. Thereafter, the flow goes back to step 54.

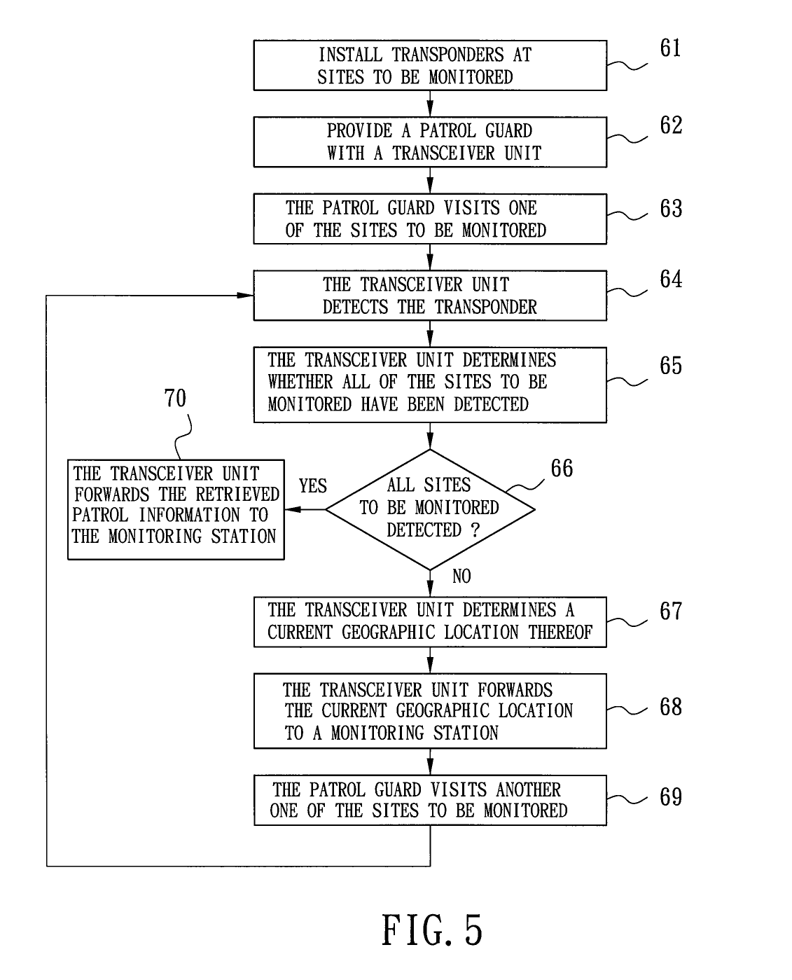

The third preferred embodiment of a patrolling method to be implemented using the aforementioned patrolling system 2 according to this invention includes the steps shown in FIG. 5.

In step 61, the transponders 22 are installed at the sites 3 to be monitored, respectively.

In step 62, the patrol guard is provided with the transceiver unit 23.

In step 63, the patrol guard visits one of the sites 3 in the predetermined set. In this embodiment, the predetermined set of the sites 3 includes all the sites 3 to be monitored.

In step 64, the patrol guard uses the RFID reader 2311 of the sensor module 231 of the transceiver unit 23 to detect the RFID tag 221 of the transponder 22 installed at the visited site.

In step 65, the transceiver unit 23 determines whether the RDIF tags 221 of the transponders 22 at all of the sites 3 in the predetermined set have been detected.

In step 66, if the transceiver unit 23 determines in step 65 that the RDIF tags 221 of the transponders 22 at all of the sites 3 in the predetermined set have been detected, the flow proceeds to step 70. Otherwise, the flow proceeds to step 67.

In step 67, the second transceiver module 233 of the transceiver unit 23 determines a current geographic location of the transceiver unit 23.

In step 68, the second transceiver module 233 of the transceiver unit 23 forwards the current geographic location to the monitoring station 21.

In step 69, the patrol guard visits another one of the sites 3 to be monitored. Thereafter, the flow goes back to step 64.

In step 70, the first transceiver module 232 of the transceiver unit 23 forwards the retrieved patrol information to the monitoring station 21.

In this embodiment, the patrol guard visits the sites 3 to be monitored by following a fixed route. As such, the monitoring site 21 does not need to instruct the patrol guard of a site 3 to be visited next. This reduces operating load of the monitoring station 21.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A patrolling method to be implemented using
a monitoring station,
a plurality of transponders that have corresponding patrol information stored therein, and
a transceiver unit that includes a sensor module capable of retrieving the patrol information from the transponders, a first transceiver module capable of forwarding retrieved patrol information to the monitoring station, and a second transceiver module capable of determining a current geographic location of the transceiver unit and forwarding the current geographic location to the monitoring station,
said patrolling method comprising the steps of:
a) installing the transponders at a plurality of sites to be monitored, respectively;
b) providing a patrol guard with the transceiver unit such that the patrol guard is able to use the transceiver unit to detect the transponder installed at one of the sites to be monitored so as to retrieve the patrol information thereof;
c) enabling operation of the transceiver unit to forward the retrieved patrol information to the monitoring station via the first transceiver module; and
d) enabling operation of the transceiver unit to forward the current geographic location thereof to the monitoring station via the second transceiver module.

2. The patrolling method as claimed in claim 1, wherein, in step c), the first transceiver module is configured to forward the retrieved patrol information to the monitoring station immediately upon detection by the sensor module of the transponder at said one of the sites to be monitored.

3. The patrolling method as claimed in claim 1, wherein, in step c), the first transceiver module is configured to forward the retrieved patrol information to the monitoring station after detection by the sensor module of the transponders at a predetermined set of the sites.

4. The patrolling method as claimed in claim 1, wherein, in step d), the second transceiver module is configured to forward the current geographic location of the transceiver unit to the monitoring station upon detection of a change in the current geographic location.

5. The patrolling method as claimed in claim 1, wherein, in step d), the second transceiver module is configured to forward the current geographic location of the transceiver unit to the monitoring station upon detection by the sensor module of the transponder at said one of the sites to be monitored.

6. The patrolling method as claimed in claim 1, wherein each of the transponders includes a radio frequency identification (RFID) tag that stores the patrol information, and the sensor module of the transceiver unit includes a RFID reader.

7. The patrolling method as claimed in claim 1, wherein, in step c), the first transceiver module accesses a service provided by a mobile communications service provider in forwarding the patrol information to the monitoring station.

8. The patrolling method as claimed in claim 1, wherein, in step d), the second transceiver module accesses a service provided by a global positioning system (GPS) service provider in determining the current geographic location of the transceiver unit.

9. The patrolling method as claimed in claim 1, further comprising:
e) enabling the monitoring station to instruct the patrol guard to visit another one of the sites to be monitored after step c).

10. The patrolling method as claimed in claim 9, wherein, in step e), said another one of the sites to be monitored is randomly selected by the monitoring station.

11. A patrolling system, comprising:
a monitoring station;
a plurality of transponders having corresponding patrol information stored therein, and adapted to be installed at a plurality of sites to be monitored, respectively; and
a transceiver unit including
a sensor module that is capable of detecting said transponders so as to retrieve the patrol information therefrom,
a first transceiver module that is coupled to said sensor module, and that is capable of forwarding retrieved patrol information to said monitoring station, and
a second transceiver module that is capable of determining a current geographic location of said transceiver unit and forwarding the current geographic location to said monitoring station.

12. The patrolling system as claimed in claim 11, wherein said first transceiver module is configured to forward the retrieved patrol information to said monitoring station immediately upon detection by said sensor module of said transponder at one of the sites to be monitored.

13. The patrolling system as claimed in claim 11, wherein said first transceiver module is configured to forward the retrieved patrol information to said monitoring station after detection by said sensor module of said transponders at a predetermined set of the sites.

14. The patrolling system as claimed in claim 11, wherein said second transceiver module is configured to forward the current geographic location of said transceiver unit to said monitoring station upon detection of a change in the current geographic location.

15. The patrolling system as claimed in claim 11, wherein said second transceiver module is configured to forward the current geographic location of said transceiver unit to said monitoring station upon detection by said sensor module of said transponder at one of the sites to be monitored.

16. The patrolling system as claimed in claim 11, wherein each of said transponders includes a radio frequency identification (RFID) tag that stores the patrol information, and said sensor module of said transceiver unit includes a RFID reader.

17. The patrolling system as claimed in claim 1l, wherein said first transceiver module accesses a service provided by a mobile communications service provider in forwarding the patrol information to said monitoring station.

18. The patrolling system as claimed in claim 11, wherein said second transceiver module accesses a service provided by a global positioning system (GPS) service provider in determining the current geographic location of said transceiver unit.

19. The patrolling system as claimed in claim 11, wherein said monitoring station instructs the patrol guard to visit another one of the sites to be monitored after receiving the patrol information retrieved and forwarded by said first transceiver module of said transceiver unit.

20. The patrolling system as claimed in claim 19, wherein said another one of the sites to be monitored is randomly selected by said monitoring station.
